(19) United States
(12) Patent Application Publication
(10) Pub. No.: US 2010/0175626 A1
(43) Pub. Date: Jul. 15, 2010

(54) ANIMAL WASTE PAD DISPENSER AND HOLDER

(75) Inventor: Barry Askinasi, Mt. Sinai, NY (US)

Correspondence Address: Kane Kessler P.C., 1350 Avenue of the Americas, 26th Floor, New York, NY, 10019, US

(73) Assignee: Four Paws Products, Ltd., Hauppauge, NY (US)

(21) Appl. No.: 12/510,567

(22) Filed: Jul. 28, 2009

Related U.S. Application Data
(60) Provisional application No. 61/143,502, filed on Jan. 9, 2009.

(51) Int. Cl. A01K 29/00

(52) U.S. Cl. 119/169; 119/161

(57) ABSTRACT

An animal waste pad device that dispenses waste pads from a roll of animal waste pads and holds the animal waste pads in place for use by an animal.

### CROSS-REFERENCE TO RELATED APPLICATION

The present application claims the benefit of U.S. Provisional Application Ser. No. 61/143,502, filed on Jan. 9, 2009, which is hereby incorporated by reference in its entirety.

### FIELD OF THE INVENTION

The present invention generally relates to a device that dispenses and holds disposable animal waste pads. More specifically, the device contains a compartment for storing rolled animal waste pads which may be dispensed across and held in place over a waste bed for use by an animal.

### BACKGROUND OF THE INVENTION

Disposable waste pads provide convenience for owners of domestic animals, such as dogs. A waste pad provides an area for a dog to relieve itself without damaging flooring and making cleanup easier. These pads are useful for the housebreaking process for puppies, as well as for older dogs that are left in the home for prolonged periods of time.

The disposable pads are often left on the floor for the dog to use. Providing the pads in a predetermined area provides consistency to the animal using the pad, and helps to designate and reinforce the use of the pad in a specified area. However, pads by themselves can be easily moved across the floor either by the pet owners kicking or stepping on the pad or when the dog uses the pad. The dog may chew, gnaw, drag, fold, cause the pad to bunch up, or otherwise damage or destroy the pad. Also, it can be difficult for the pet owner to place the pad consistently in a predetermined location for the animal.

Further, once a pad has been soiled, a new pad is needed as a replacement. New pads are often sold folded in a package wherein the pads are stacked one on top of the other. Thus, to replace the soiled pad, the user must locate the package of separately stored new pads, remove the pad, unfold the pad to its full area, and place the pad at its location on the floor.

Therefore, it would be advantageous to have a device that would hold a pad for use by the animal, and provide storage and easy access to replacement pads.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of waste pad dispenser and holder in accordance with one embodiment of the present invention.

FIG. 2 is a top view of waste pad dispenser and holder having a clean waste pad therein and a section of a soiled waste pad to be removed extending outwardly therefrom in accordance with one embodiment of the present invention;

FIG. 3 is a sectional view of dispenser with the lid open in accordance with one embodiment of the present invention;

FIG. 4 is a perspective view of waste pad receptacle with the lid and clamp open and a perspective view of waste pad roll on the spindle, wherein the roll and spindle is shown unassembled from waste pad receptacle;

FIG. 5 is a side view of the roll and spindle in accordance with one embodiment of the present invention;

FIG. 6 is a perspective view of the spindle in accordance with one embodiment of the present invention;

FIG. 7 is a perspective view of waste pad dispenser and holder in accordance with another embodiment of the present invention;

FIG. 8 is an exploded view of waste pad dispenser and holder in accordance with another embodiment of the present invention;

FIG. 9 is a front view of waste pad dispenser in an open position in accordance with another embodiment of the present invention;

FIG. 10 is a top view of waste pad dispenser and holder in accordance with another embodiment of the present invention;

FIG. 11 is a section view of the lid of waste pad dispenser in accordance with another embodiment of the present invention;

FIG. 12 is a sectional view of a clamp of waste pad holder in accordance with another embodiment of the present invention;

FIG. 13 is a sectional view of a holder of waste pad holder in accordance with another embodiment of the present invention; and

FIG. 14 is a bottom view of waste pad dispenser and holder in accordance with another embodiment of the present invention.

### DETAILED DESCRIPTION OF THE PREFERRED EMBODIMENTS

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

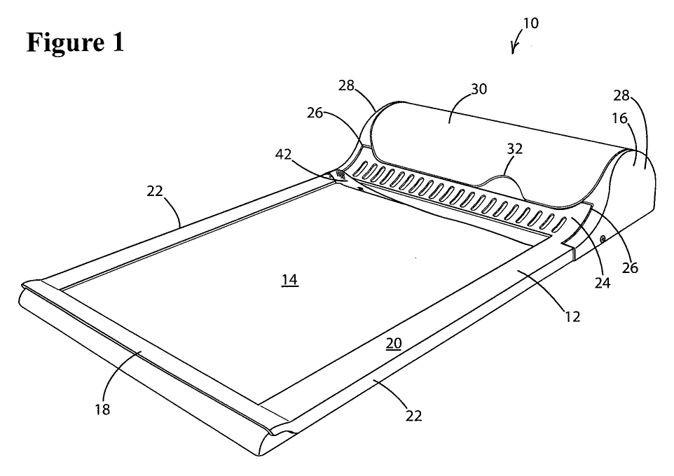

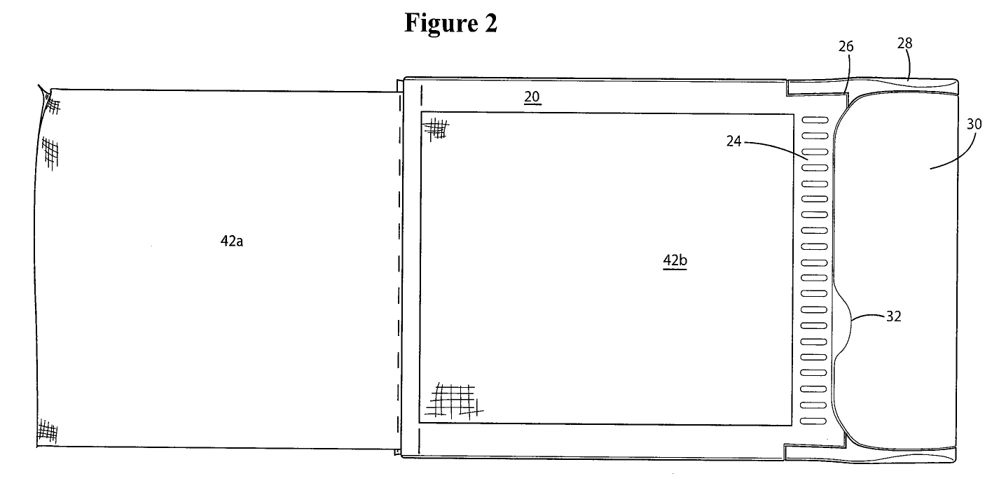

Referring to FIGS. 1-7, waste pad dispenser and holder 10 is shown for storing, dispensing and holding waste pads 42 to facilitate the housebreaking of domestic pets, such as dogs and cats, and to provide a place for the pets to urinate or defecate when they can not be let out of the house for a prolonged period of time.

Waste pads 42 are typically disposable and are generally comprised of three layers of materials. The top layer is typically made of a non-woven material, such as polyester, with a wicking action, the middle layer is usually a cellulose tissue embedded with a superabsorbent polymer, and the bottom later is generally an impermeable backing such as polypropylene. Waste pads 42 may also be scented to cut down on odors, including scents that are moisture activated. Waste pad dispenser and holder 10 may be provided in a number of different sizes depending on the size of the domestic pet. Waste pad dispenser and holder 10 includes dispenser 16 for storing waste pad roll 40 and permitting the easy loading of waste pads 42 onto waste-bed 14. Waste pads 42 are loaded one at a time from waste pad roll 40 and are secured on waste-bed 14 by clamp 12. Clamp 12 is comprised of frame 20 encompassing a substantially open center region such that when waste pad 42 is loaded it is held down at its periphery and the rest of waste pad 42 is exposed, thereby providing a relatively large surface for the pet to use.

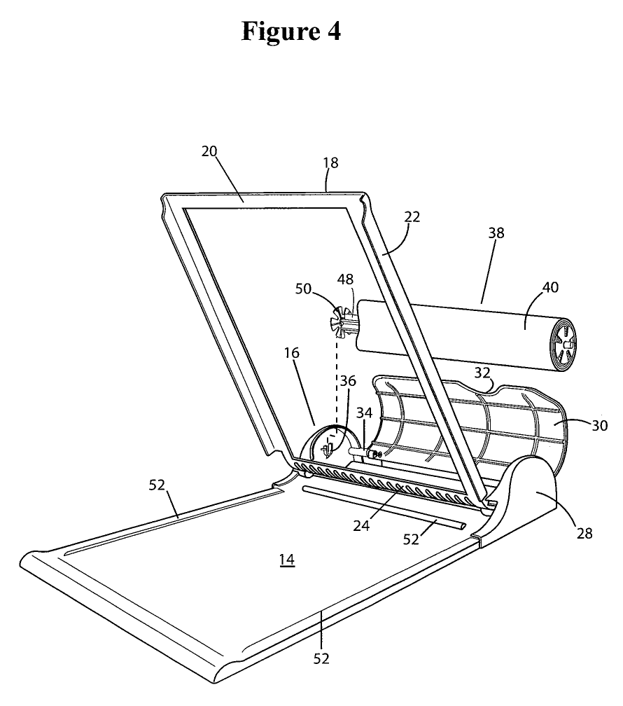

Clamp 12 is comprised of handle 18, frame 20, sidewalls 22 and roll guide 24. Sidewalls 22 slidably engage the sides of waste-bed 14 when clamp 12 is in a closed position such that frame 20 holds waste pad 42 against waste-bed 14 at its peripheral edges. Clamp 12 is connected to dispenser 16 at clamp hinges 26 proximate the back edge of roll guide 24. Roll guide 24 may be flat, but is preferably arcuate to provide a smooth surface that will not catch waste pads 42, or perforations therebetween, as waste pads 42 are loaded onto waste-bed 14. Thus, regardless of how far clamp 12 is opened and independent of the orientation of waste pad roll 40, it is preferable, although not required, that waste pads 42 should roll out cleanly. Handle 18 is disposed at the front of clamp 12 and opposite clamp hinges 26 so that clamp 12 may easily be opened and closed. Preferably, handle 18 extends outwardly and upwardly from the front of waste-bed 14 so that the pet's caretaker may easily place one or more fingers below handle 18 and pull upwardly, thereby rotating clamp 12 at clamp hinges 26 and separating frame 20 from waste-bed 14. The resulting open orientation of clamp 12 is shown in FIG. 4. In alternative embodiments, clamp 12 may instead be hinged at one of the sides of waste-bed 14 and thus open in a different direction than the one shown.

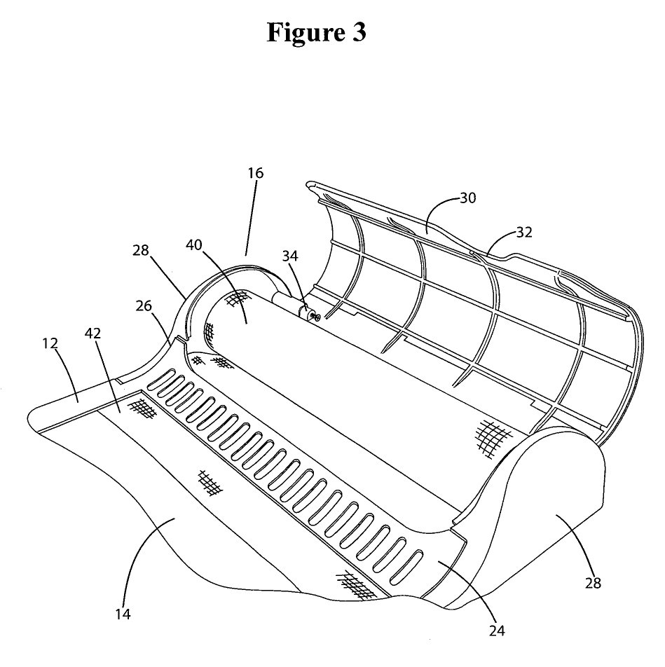

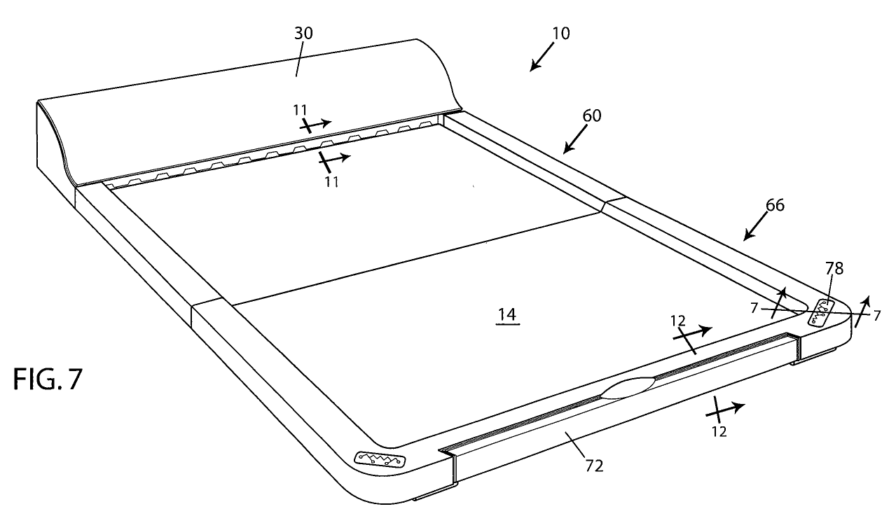

Referring to FIGS. 3-6, dispenser 16 is located at the rear portion of waste pad receptacle 10 and includes end faces 28 and lid 30. On the interior wall of each end face 28 is cradle 36 which supports roll and spindle 48 within dispenser 16. Access to this central region of dispenser 16 is provided by opening lid 30 which is hingeably secured to the rear of dispenser 16 at lid hinges 34. In other embodiments, lid 30 may hinged at the front or along either side. To facilitate opening and closing of lid 30, it is preferable to provide recess 32 therein. While any type of handle could be used to facilitate the opening and closing of lid 30, providing recess 32 is a simple way to allow the pet's caretaker to easily get one or more fingers under lid 30 to open it and also provides a window for the caretaker to easily determine how many waste pads 42 are left on waste pad roll 40. Lid 30 is shown open in FIGS. 6 and 7, revealing the interior space of dispenser 16.

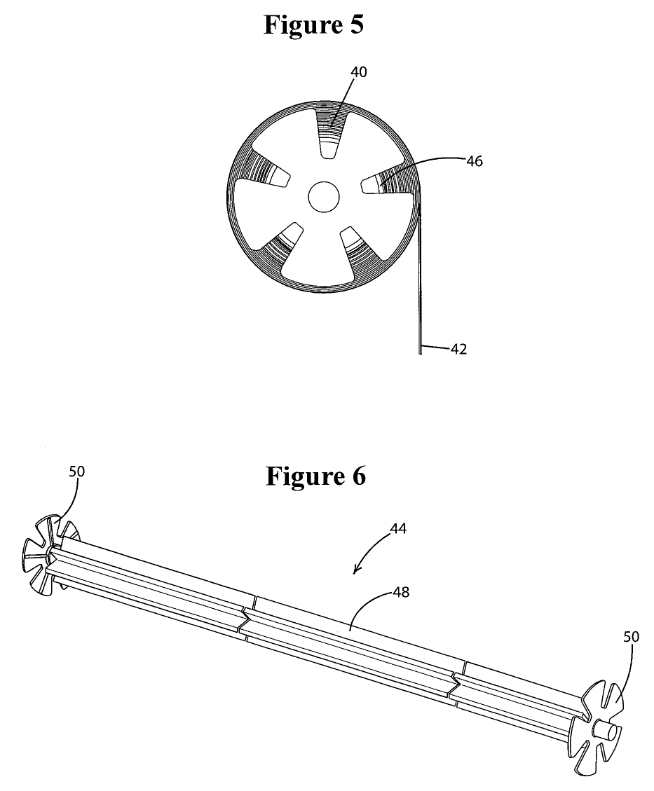

Referring to FIGS. 5-6, roll and spindle 48 comprises waste pad roll 40 and spindle 44. Waste pad roll 40 is comprised of a plurality of waste pads 42 which are preferably consecutively arranged and separated by perforations. In one embodiment, a hollow, cylindrical roll frame 46 is provided at the interior of waste pad roll 40. The roll frame 46 may be composed of cardboard, plastic or the like and serves both to provide structure to waste pad roll 40 and to define a hollow, cylindrical space corresponding to spindle 44. The plurality of waste pads are rolled about the roll frame 46 to create waste pad roll 40. Spindle 44 comprises shaft 48 and roll faces 50. Shaft 48 may be a number of shapes, such as cylindrical, or may be comprised of a plurality of radial protrusions which terminate along a cylindrical path as shown in FIG. 6. Preferably, the end portions of shaft 48 are cylindrical, extending past roll faces 50 and corresponding to the U-shaped cradles 36. Roll faces 50 are substantially flat and may be a number of shapes, such as disc-shaped, and may be provided with or without the recesses shown in FIG. 6. At least one of roll faces 50 is removable so that waste pad roll 40 may be mounted onto spindle 44. For example, one of the roll faces 50 may be removable by providing the roll face with a central aperture sized closely to or slightly less than the diameter of shaft 48 at the end portions thereof to create a tight-fit or an interference fit. Alternatively, the removability could be provided via a snap-fit, or other interconnect, could be achieved through corresponding internal and external threading provided inside a central hole of roll face 50 and outside shaft 48, respectively, or the diameter of shaft 48 could gradually increase inwardly, such that when removable roll face 50 is pressed thereon, a tight-fit is achieved.

To load waste pad roll 40 onto spindle 44, one of roll faces 50 is removed and the inside of waste pad roll 40 is slid over shaft 48. Once waste pad roll 40 has been installed onto shaft 48, roll face 50 may be reattached. In one embodiment, the ends of waste pad roll 40 abut, or are closely proximate to, the interior sides of roll faces 50 to prevent lateral movement of waste pad roll 40 when mounted on spindle 44. In an alternative embodiment, this lateral movement could be prevented by creating a tight-fit or interference-fit between the interior of waste pad roll 40 and shaft 48, in which case roll faces 50 would not be necessary. Once roll and spindle 38 has been assembled, it is inserted into dispenser 16 by placing the ends of shaft 48 into cradles 36 as shown by the dotted line in FIG. 4. The length of shaft 48 should be just shorter than the distance between the interior edges of end faces 28 and the diameter of the ends of the shaft should be just smaller than the size of the U-shaped cradles 36 to provide for easy rotation of roll and spindle 38 with minimal lateral movement.

Additionally, as mentioned above, spindle 44 may be provided in a variety of different designs. For example, spindle 44 may be broken up into one or more parts so that when it is taken off cradles 36, it can be pulled apart to replace waste pad roll 40. Alternatively, spindle 44 may be provided in at least two parts which overlap and are biased by a spring, such as the case with commonplace toilet paper dispensers. In such an embodiment, cradles 36 could be replaced by circular apertures in, or hollow circular protrusions from, end faces 28. In this way, spindle 44 could be moved in and out of dispenser 16 by simply pressing the two parts of spindle 44 toward each other.

Referring to FIG. 4, waste-bed 14 is preferably substantially flat, though it may be provided with somewhat of a recess, and may also be provided with one or more ribs 52 protruding from the top surface thereof and positioned beneath or just inside frame 20. Accordingly, ribs 52 could be provided near any of the corners or sides, or near the front or the rear of waste-bed 14 to facilitate the retention of waste pads 42 by creating a tighter grip on the peripheries thereof. Ribs 52 could be made out of the same material as waste pad receptacle 10, e.g., plastic, or could be made out of a resilient material having a higher coefficient of friction, e.g., rubber, to better retain waste pad 42 and prevent it from sliding around on waste-bed 14. The stronger the retention force exerted on waste pads 42 between clamp 12 and waste-bed 14 the less likely it is that waste pad 42 will move around or become bunched, thereby creating a mess. Further, in one embodiment, waste-bed 14 is provided with feet, preferably rubber feet, or ridges on the bottom surface to prevent waste pad receptacle 10 from sliding around on the floor, which could otherwise occur if bumped into, used by larger pets or kept on a slick surface.

Clamp 12, waste-bed 14 and dispenser 16, including lid 30 and spindle 44, may be created from any number of materials such as plastic, metal, glass, wood, etc., in various combinations, though they are preferably composed of plastic. In this way, the material costs and the overall production cost could be reduced. Additionally, the components may be formed through numerous operations such as molding, cutting, blanking, vacuum forming, etc., though they are preferably formed by injection molding. Further, lid 30 may be made transparent so that a pet's caretaker may easily look down into the interior of dispenser to get an approximation of the number of waste pads 42 remaining on waste pad roll 40 to determine when a change will be needed.

In one embodiment described above, the pet's caretaker may purchase new waste pad rolls 40 for the purpose of replacement as they become used up. Alternatively, new rolls and spindles 38 could be supplied such that the step of mounting waste pad roll 40 onto spindle 44 is eliminated and the new roll and spindle 38 could be mounted directly into the cradles 36.

Referring to FIGS. 3 and 4, in operation, clamp 12 is opened and the first waste pad on waste pad roll 40 is drawn out over waste-bed 14 until the front of waste pad 42 is proximate the front of handle 18. Clamp 12 is then closed, thereby securing waste pad 42 at its periphery between frame 20 and waste-bed 14. The domestic pet (who has been taught, or is being taught, to use waste pads 42 at or near the location in the house or apartment where waste pad receptacle 10 is being kept) enters onto waste-bed 14 from either of the sides or the front and then uses waste pad 42 contained within waste pad receptacle 10. Since the entranceway to waste-bed 14 is open to entrance from any side, there is no limit to the locations within the home that waste bed receptacle can be kept. Once first waste pad 42a has become soiled and needs to be replaced, the pet's caretaker opens clamp 12 by lifting up on handle 18. The caretaker then grabs soiled waste pad 42a at the front or at the sides, preferably where waste pad 42a is assuredly clean from being under frame 20, and pulls waste pad 42a forward. As the soiled waste pad 42a is pulled forward, a new waste pad 42b is pulled out of dispenser 16 via waste pad roll 40 turning and incrementally unrolling. Once the perforation line separating waste pads 42a and 42b is approximately inline with the front of handle 18, clamp 12 is closed and the soiled waste pad 42a is torn off at the perforations. Handle 18 may be used to assist in the tearing by holding the front of new waste pad 42b in place while the soiled waste pad 42a is pulled upwards or forward away from waste pad roll 40, thereby separating waste pads 42a and 42b.

This automatic loading of new waste pads 42b by the removal of the soiled waste pads 42a greatly simplifies the task of changing waste pads 42 in general, as the location of new waste pads 42b need not be determined and the pet's caretaker need not touch or reach over contaminated sections of the soiled waste pads 42a. Accordingly, removal and installation have been simplified into one easy step. In other embodiments, soiled waste pad 42a could be torn from waste pad roll 40 prior to the loading of the new waste pad 42b or after the loading of new waste pad 42b, but prior to closing clamp 12.

Once waste pad roll 40 is empty, lid 30 is opened and roll and spindle 38 is removed by pulling it upwardly out of cradles 36. At least one of the roll faces is removed and roll frame 46, if provided, is slid off of shaft 48. Then, a new waste pad roll 40 is slid back onto shaft 48, roll face 50 is reattached, the refilled roll and spindle 38 is placed back into cradles 36 and lid 30 is closed. In this manner, waste pad receptacle 10 transforms the constant, necessary replacement of waste pads 42 from a time-consuming chore into a simple and easy task.

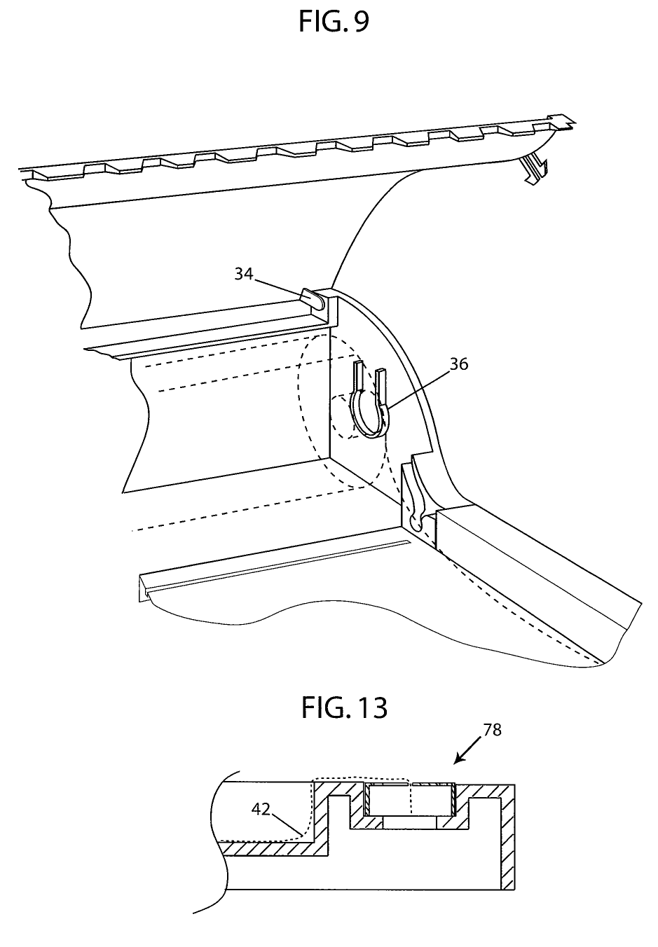

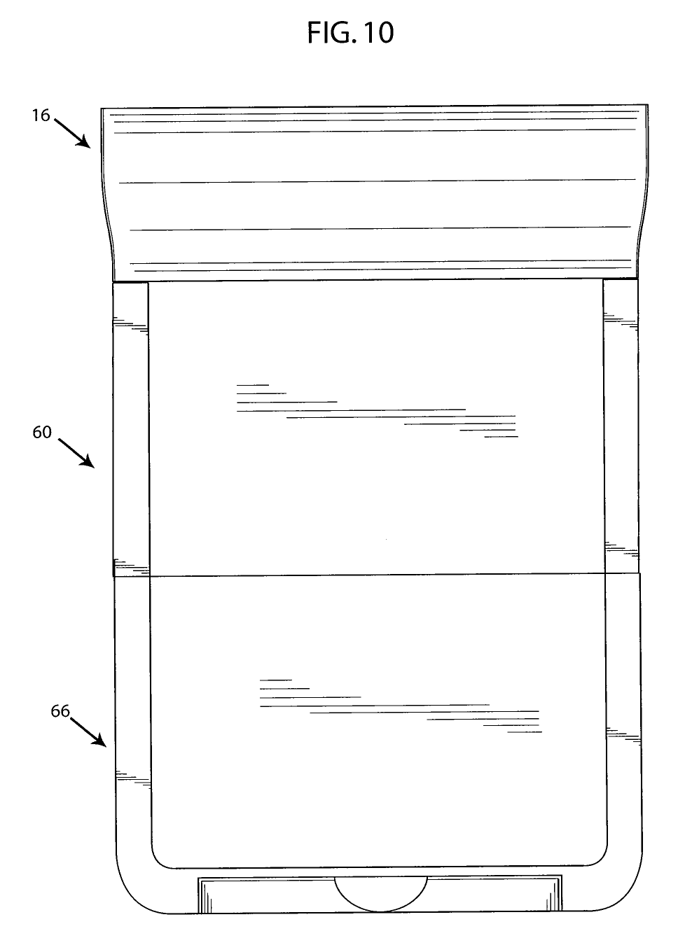

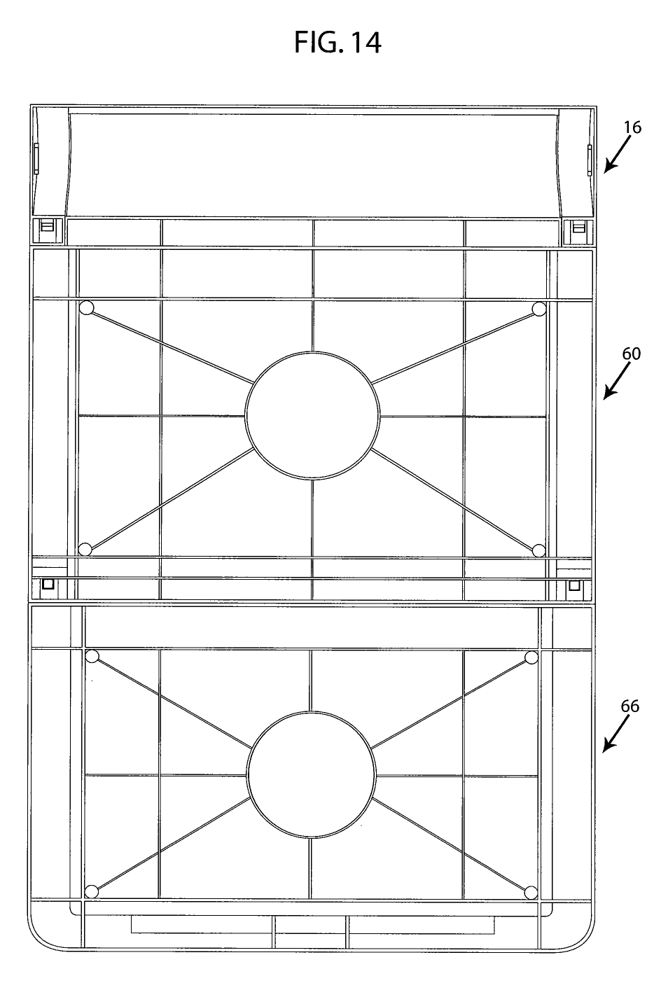

Another embodiment of waste pad dispenser and holder 10 is shown in FIGS. 7-14. In this embodiment, waste bed 14 is comprised of two separate sections, first waste bed section 60 and second waste bed section 66. In one embodiment, waste bed 14 is substantially flat and planar. In another embodiment, waste bed 14 may be concave so as to pool waste towards its center. The two waste bed sections are connectable through prongs 68 attached to one end of second waste bed section 66 that interface with prong receiving opening 70 of first waste bed section 60. Similarly, first waste bed section 60 is removably connectable to dispenser 16 through prongs 62 and prong receiving openings 64 in dispenser 16. By providing different sections for the waste pad holder and dispenser, the device may be sold in a reduced packaging and therefore meet requirements of retailers having space constrictions for their shelves. The reduced size also decreases shipping costs and the difficulty in a consumer bringing the waste pad dispenser and holder to their homes. The use of prongs and prong receiving openings enables a consumer to quickly and easily assemble the device without the use of tools.

Waste bed 14, in this embodiment, contains raised edges 61 that extend along the edges of three peripheral sides of waste bed. Raised edges 61 act to contain waste pads within waste bed 14 and also to prevent any leaking or spillage off the waste pad holder. On one end of waste bed 14 is pad clamp 72. Pad clamp 72 is comprised of a hinged piece that acts as a clamp when one end of waste pad 42 is placed within the clamp. As an alternative, the peripheral edges of waste bed 14 may contain pad retainers 78. Pad retainers 78 are comprised of a deformable plastic, rubber or similar materials. When the waste pad is inserted into pad retainers 78, the deformable material initially moves to create a space through with the waste pad may be inserted. After insertion of the waste pad, the deformable material moves back into its original position, engaging and holding the waste pad in place. Any combination or number of pad clamps and pad holders may be used to hold the waste pad in place.

In another embodiment, the lower surface of the waste pads may be treated with a slightly adhesive material that increases the tackiness of the surface. When the waste pads are place over bed 14, the slightly adhesive nature of the back surface of the waste pads will cause them to adhere to bed 14. Alternatively, bed 14 may be made of a material that has an adhesive property relative to the back surface of the waste pads to accomplish the same results.

Dispenser 16 may contain cradles 36 for holding waste pad roll 40. In this embodiment, roll 40 may be inserted so as to rest within cradles 36 without deformation of either end face 28. In one embodiment of the invention, pad roll 40 is provided with a spindle in the replacement waste pad roll so that the user need only insert the replacement waste pad roll directly into the dispenser. Any other method of rotatably holding waste pad roll 40 within dispenser 16 may be used.

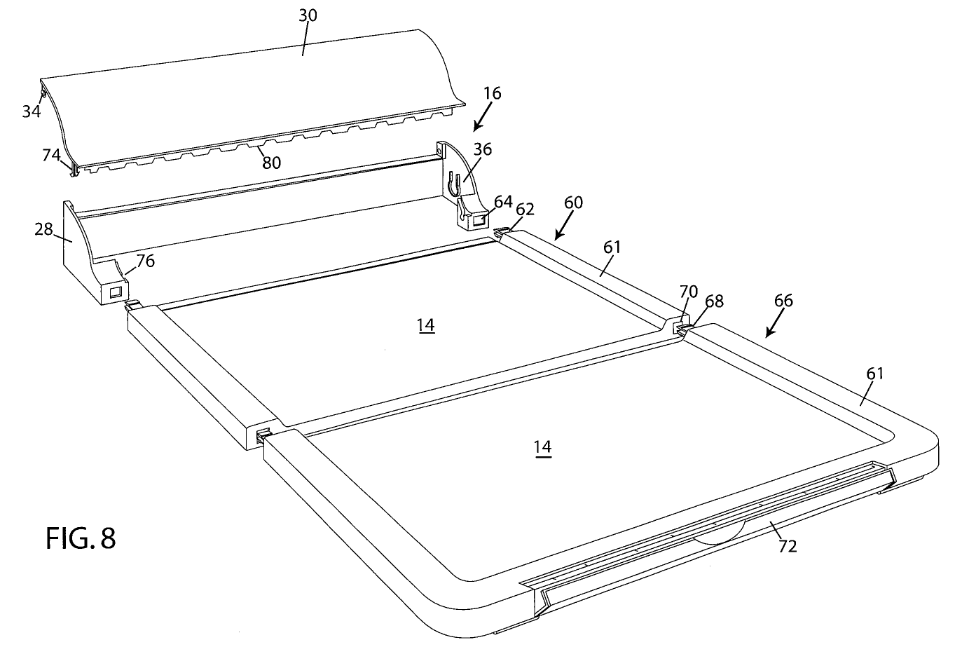

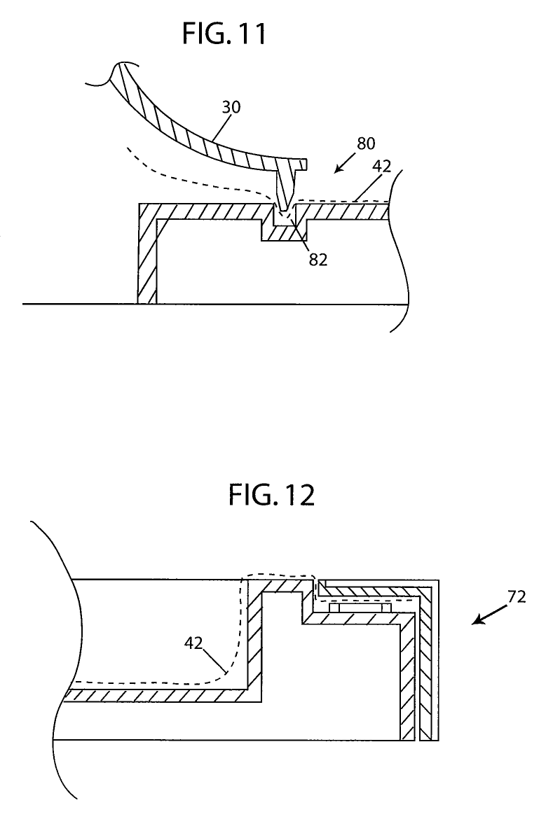

Lid 30 may contain extended edge 80 as shown in FIGS. 8 and 11. Extended edge 80 may fit into a receiving opening 82 when lid 30 is placed into its closed position. When pad 42 is placed within the device and lid 30 is moved into its closed position, pad 42 will be held in place between the extended edge 80 and receiving opening 82 as shown in FIG. 11.

In operation, a user will open lid 30 to gain access to the interior of dispenser 16. The user would then place a roll of animal waste pads within dispenser 16, which are rotatably held in place by cradles 36. The user may then extend an animal waste pad across waste bed 14 and insert the end of the animal waste pad into pad clamp 72 or within one or more of pad retainers 78. The user may then close lid 30 to hold the opposite end of the animal waste pad in place. Alternatively, lid 30 may simply rest against the opposite end of the waste pad holder to trap the waste pad against waste bed 14. In yet another embodiment, lid 30 may have extensions 74 (FIG. 8) which mate into extension receiving opening of the body of dispenser 16 to removeably hold the lid in a closed position.

After a waste pad that is lying on waste bed 14 is soiled, the pet owner will disengage pad clamp 72 or pad retainers 78. The pad may then be pulled off of waste bed 14, thereby causing the next trailing, and unused, waste pad to be positioned on the waste bed. The pet owner may then remove the soiled waste pad by separating it at the perforation from the next waste pad. Alternatively, the pet owner may chose to first detach the current waste pad from the following pad and manually advance the next waste pad into position. In yet another embodiment, the user would not lift lid 30 when changing waste pad. Rather, the waste pad would be dispensed from a slot created between lid 30 and the edge of waste bed 14. In yet another embodiment, extended edge 80 would act to cut waste pad at that location when lid 30 is closed.

While the invention has been particularly shown and described with reference to preferred embodiments thereof, it will be understood by those skilled in the art that various changes in form and details may be made therein without departing from the spirit and scope of the invention.

1. An animal waste pad device comprising:
a dispenser having
a body configured to hold a roll of animal waste pads and having a lid moveable between a closed position and an open position;
supports for holding and permitting rotational movement of the roll of animal waste pads;
the lid containing a pad retention edge; and
a holder coupled to the dispenser and having
a substantially flat bed;
three raised peripheral edges;
at least one pad retaining feature at an end opposite the dispenser.

2. The animal waste pad device of claim 1 wherein the substantially flat bed of the holder has two or more connectedly separate pieces.

3. The animal waste pad device of claim 1 wherein the dispenser is connectedly separate from the holder.

4. The animal waste pad device of claim 1, further comprising:
the roll of animal waste pads extending between the supports.

5. The animal waste pad device of claim 1, further comprising:
the roll of animal waste pads having a plurality of individual waste pads connected consecutively via a perforated edge and extending between the supports.

6. An animal waste pad dispenser and holder comprising:
an animal waste pad dispenser having a body with a hinged lid and configured to hold a roll of animal waste pads;
a means for rotatably holding the roll of animal waste pads within the animal waste pad dispenser;
a substantially flat bed; and
a means for holding the animal waste pad on the flat bed so that an animal may use the animal waste pad.

7. The dispenser and holder of claim 6 wherein the substantially flat bed of the holder has two or more connectedly separate pieces.

8. The dispenser and holder of claim 6 wherein the dispenser is connectedly separate from the holder.

9. The dispenser and holder of claim 6 wherein the hinged lid contains an extended edge for holding the animal waste pad in position when the lid is in a closed position.

10. The dispenser and holder of claim 6 wherein the hinged lid contains an edge for aiding in the separation of the waste pad from a subsequent waste pad.

11. The dispenser and holder of claim 6, further comprising:
the roll of animal waste pads is coupled to the means for rotatably holding the roll of animal waste pads.

12. The dispenser and holder of claim 6, further comprising:
the roll of animal waste pads having a plurality of individual waste pads connected consecutively via a perforated edge and is coupled to the means for rotatably holding the roll of animal waste pads.

13. The dispenser and holder of claim 11 wherein the roll of animal waste pads contains a spindle that interconnects with the means for rotatably holding the roll of animal waste pads.
